(19) United States
(12) Patent Application Publication
(10) Pub. No.: US 2025/0158928 A1
(43) Pub. Date: May 15, 2025

(54) EFFECTIVELY DETECTING AND HANDLING CONGESTION USING FPIN BASED EVENTS IN VIRTUAL ENVIRONMENTS

(71) Applicant: International Business Machines Corporation, Armonk, NY (US)

(72) Inventors: Venkateshwar R. YERRAVALLI, Hyderabad (IN); Yadagiri RAJABOINA, Hyderabad (IN); Phani Kumar V.U. AYYAGARI, Hyderabad (IN); Vinayaka KARNE, Hyderabad (IN); Bharath Kumar GUTHA, Anantapur (IN)

(21) Appl. No.: 18/508,982

(22) Filed: Nov. 14, 2023

(51) Int. Cl. H04L 47/125; H04L 47/20; H04L 47/2416

(52) U.S. Cl. CPC H04L 47/125; H04L 47/20; H04L 47/2416

(57) ABSTRACT

Disclosed embodiments provide methods, systems, and computer program products for implementing intelligent congestion control of data transfers in Fibre Channel (FC) communication paths based on an associated priority of workloads running on respective virtual machines (VMs). In a disclosed embodiment, a host server comprises a Virtual IO Server (VIOS) with Nport ID Virtualization (NPIV) technology to manage the multiple VMs; receives Fabric Performance Impact Notification (FPIN) congestion event notifications and transmits the FPIN congestion event notifications to the VMs with a respective throttle factor configured for respective VMs. Disclosed embodiments throttle IO operations of the VMs based on a priority of the VMs to implement intelligent congestion control, and restore IO operations of the VMs in a VM group order based on a reverse VM priority when the congestion event is cleared.

### BACKGROUND

The present invention relates to the data processing field, and more specifically, to implementing congestion control in Fibre channel (FC) communication paths of virtual computing environments.

Some virtual computing environments employ a Fabric performance impact notification (FPIN) generated by FC fabric for providing a congestion notification when congestion is encountered in one or multiple FC communication paths. Various techniques are used to clear the congestion; however, these techniques may be complex and limited in their application.

### SUMMARY

Embodiments of the present disclosure provide methods, systems, and computer program products for implementing intelligent congestion control in Fibre channel (FC) communication paths of a computing environment using Fabric performance impact notification (FPIN) events.

According to one embodiment of the present disclosure, a non-limiting computer implemented method is provided. The method comprises receiving a congestion event notification for a plurality of Virtual Machines (VMs); and transmitting the congestion event notification with a first throttle factor to a first VM group of one or more VMs having a lowest VM priority of the plurality of VMs, where the first throttle factor is configured based on the lowest VM priority, to throttle IO operations of the lowest priority VMs based on the first throttle factor. The method also includes transmitting, based on congestion duration, the congestion event notification with a second throttle factor to a next VM group of one or more VMs having a next higher VM priority of the plurality of VMs, where the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and sequentially restoring IO operations of the VMs in a VM group order based on the VM priority of the respective VM groups in response to the congestion event being cleared.

According to one embodiment of the present disclosure, a system is provided. The system includes one or more computer processors, and a memory containing a program which when executed by the one or more computer processors performs an operation. The operation comprises receiving a congestion event notification for a plurality of Virtual Machines (VMs); and transmitting the congestion event notification with a first throttle factor to a first VM group of one or more VMs having a lowest VM priority of the plurality of VMs, where the first throttle factor is configured based on the lowest VM priority, to throttle IO operations of the lowest priority VMs based on the first throttle factor. The operation also includes transmitting, based on congestion duration, the congestion event notification with a second throttle factor to a next VM group of one or more VMs having a next higher VM priority of the plurality of VMs, where the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and sequentially restoring IO operations of the VMs in a VM group order based on the VM priority of the respective VM groups in response to the congestion event being cleared.

According to one embodiment of the present disclosure, a computer program product is provided. The computer program product includes a computer-readable storage medium having computer-readable program code embodied therewith, the computer-readable program code executable by one or more computer processors to perform an operation. The operation comprises receiving a congestion event notification for a plurality of Virtual Machines (VMs); and transmitting the congestion event notification with a first throttle factor to a first VM group of one or more VMs having a lowest VM priority of the plurality of VMs, where the first throttle factor is configured based on the lowest VM priority, to throttle IO operations of the lowest priority VMs based on the first throttle factor. The operation also includes transmitting, based on congestion duration, the congestion event notification with a second throttle factor to a next VM group of one or more VMs having a next higher VM priority of the plurality of VMs, where the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and sequentially restoring IO operations of the VMs in a VM group order based on the VM priority of the respective VM groups in response to the congestion event being cleared.

### BRIEF DESCRIPTION OF THE DRAWINGS

FIG. 1 is a block diagram of an example computer environment for use in conjunction with one or more disclosed embodiments for implementing congestion control in communication paths of a Fibre channel (FC) fabric;

FIG. 2 is a schematic and block diagram of an example system for implementing congestion control in communication paths of a Fibre channel (FC) fabric of one or more disclosed embodiments;

FIG. 3 is a schematic and block diagram of example details of an illustrative host server of the system of FIG. 2 for implementing congestion control in communication paths of a Fibre channel (FC) fabric of one or more disclosed embodiments;

FIG. 4 is an illustrative diagram of an example QOS weightage table of one or more disclosed embodiments;

FIGS. 5A and 5B together provide a flow chart illustrating example operations of an example method for implementing congestion control in communication paths of a Fibre channel (FC) fabric of one or more disclosed embodiments; and

FIG. 6 is a flow chart of a method for implementing throttling congestion control in communication paths of a Fibre channel (FC) fabric of one or more disclosed embodiments.

### DETAILED DESCRIPTION

Embodiments of the present disclosure provide methods, systems, and computer program products for implementing intelligent congestion control of data transfers in communication paths in a computing environment. Disclosed embodiments implement intelligent congestion control of Fibre Channel (FC) communication paths based on an associated priority of workloads running on respective virtual machines (VMs). Disclosed embodiments implement intelligent congestion control to throttle IO operations of the VMs based on a priority of the VMs and a throttle factor configured for respective VMs based on the VM priority.

According to an aspect of disclosed embodiments, a non-limiting computer implemented method is provided. The method comprises receiving a congestion event notification for a plurality of VMs; and transmitting the congestion event notification with a first throttle factor to a first VM group of one or more VMs having a lowest VM priority of the plurality of VMs, where the first throttle factor is configured based on the lowest VM priority, to throttle IO operations of the lowest priority VMs based on the first throttle factor. The method also includes transmitting, based on congestion duration, the congestion event notification with a second throttle factor to a next VM group of one or more VMs having a next higher VM priority of the plurality of VMs, where the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and sequentially restoring IO operations of the VMs in a VM group order based on the VM priority of the respective VM groups in response to the congestion event being cleared. The method enables effectively and efficiently implementing congestion control. The method enables intelligent throttling of IO operations of respective VMs based on VM priority with the respective throttle factor of the VMs.

According to an aspect of disclosed embodiments, a system is provided. The system includes one or more computer processors, and a memory containing a program which when executed by the one or more computer processors performs an operation. The operation comprises receiving a congestion event notification for a plurality of Virtual Machines (VMs); and transmitting the congestion event notification with a first throttle factor to a first VM group of one or more VMs having a lowest VM priority of the plurality of VMs, where the first throttle factor is configured based on the lowest VM priority, to throttle IO operations of the lowest priority VMs based on the first throttle factor. The operation also includes transmitting, based on congestion duration, the congestion event notification with a second throttle factor to a next VM group of one or more VMs having a next higher VM priority of the plurality of VMs, where the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and sequentially restoring IO operations of the VMs in a VM group order based on the VM priority of the respective VM groups in response to the congestion event being cleared. The system enables effectively and efficiently implementing congestion control. The system enables intelligent throttling of IO operations of respective VMs based on VM priority with the respective throttle factor of the VMs.

According an aspect of disclosed embodiments, a computer program product is provided. The computer program product includes a computer-readable storage medium having computer-readable program code embodied therewith, the computer-readable program code executable by one or more computer processors to perform an operation. The operation comprises receiving a congestion event notification for a plurality of Virtual Machines (VMs); and transmitting the congestion event notification with a first throttle factor to a first VM group of one or more VMs having a lowest VM priority of the plurality of VMs, where the first throttle factor is configured based on the lowest VM priority, to throttle IO operations of the lowest priority VMs based on the first throttle factor. The operation also includes transmitting, based on congestion duration, the congestion event notification with a second throttle factor to a next VM group of one or more VMs having a next higher VM priority of the plurality of VMs, where the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and sequentially restoring IO operations of the VMs in a VM group order based on the VM priority of the respective VM groups in response to the congestion event being cleared. The computer program product enables effectively and efficiently implementing congestion control. The computer program product enables intelligent throttling of IO operations of respective VMs based on VM priority with the respective throttle factor of the VMs.

An embodiment of the present disclosure further includes configuring VM parameters of each VM of the plurality of VMs to define one or more VM parameters of a VM priority, a VM weight, and the throttle factor, where the throttle factor is configured based on the VM priority and the VM weight. The embodiment enables efficiently implementing congestion control with intelligent throttling of IO operations of respective VMs the configured throttle factor of the VMs.

Additionally, an embodiment of the present disclosure where configuring the VM parameters of each VM of the plurality of VMs is based on a respective priority of one or more applications running on the respective VMs. The embodiment enables efficiently implementing intelligent congestion control with intelligent throttling of IO operations of respective VMs based on the priority of one or more applications (e.g., workload) running on the respective VMs.

Additionally, an embodiment of the present disclosure where receiving the congestion event notification further comprises receiving a Fabric Performance Impact Notification (FPIN) congestion event for the plurality of VMs. The embodiment enables efficiently implementing intelligent congestion control with extended link service (ELS) FPIN congestion events.

Additionally, an embodiment of the present disclosure where transmitting the congestion event notification with the first throttle factor to the first VM group of one or more VMs having the lowest VM priority of the plurality of VMs further comprises transmitting the congestion event notification with a throttle factor of zero to one or more respective VM groups of VMs having the next higher VM priority of the plurality of VMs. The embodiment enables efficiently implementing congestion control with intelligent throttling of IO operations of respective VMs based on the configured throttle factor of the VMs, while maintaining IO operations of VMs having the higher VM priority of the plurality of VMs.

Additionally, an embodiment of the present disclosure where transmitting, based on the congestion duration, the congestion event notification with the second throttle factor to the next VM group of one or more VMs having the next higher VM priority further comprises transmitting the congestion event notification with a medium priority throttle factor to the next VM group of one or more VMs having a medium VM priority, where the medium priority throttle factor is configured based on the medium VM priority, to throttle IO operations of the medium priority VMs based on the medium priority throttle factor, and continuing the throttle IO operations of the lowest priority VMs based on the first throttle factor. The embodiment also includes transmitting, based on the congestion duration, the congestion event notification with a critical priority throttle factor to a next VM group of one or more VMs having critical VM priority, where the critical priority throttle factor is configured based on the critical VM priority, to throttle IO operations of the critical priority VMs based on the critical priority throttle factor, and continuing the throttle IO operations of both the medium priority VMs based on the medium priority throttle factor, and the lowest priority VMs. based on the first throttle factor. The embodiment enables efficiently implementing congestion control with intelligent throttling of IO operations of respective VMs the configured throttle factor of the VMs, while effectively enabling higher priority of IO operations of VMs having the higher VM priority of the plurality of VMs.

Additionally, an embodiment of the present disclosure where sequentially restoring IO operations of the VMs in the VM group order based on the VM priority of the respective VM groups further comprises transmitting a congestion event cleared notification with a throttle factor of zero to a first VM group of VMs having a highest VM priority of the plurality of VMs to end the throttle operations of the VMs having the highest VM priority. The embodiment enables efficiently implementing intelligent congestion control with sequentially restoring throttling of IO operations of respective VMs and effectively enables restoring higher priority IO operations of VMs having the higher VM priority.

Additionally, an embodiment of the present disclosure where the sequentially restoring IO operations of the VMs in the VM group order based on the VM priority of the respective VM groups further comprises transmitting the congestion event cleared notification with the throttle factor of zero to the VM group of VMs having a medium VM priority of the plurality of VMs to end the throttle operations of the VMs having the medium VM priority; and transmitting a congestion event clear notification with a throttle factor of zero to the VM group of VMs having the lowest VM priority of the plurality of VMs to end the throttle operations of the VMs having the lowest VM priority. The embodiment enables efficiently implementing intelligent congestion control with sequentially restoring throttling of IO operations of respective VMs in the VM group order of a highest VM priority, a medium VM priority, and a lowest VM priority.

An embodiment of the present disclosure further includes providing a host server for receiving the congestion event notification and transmitting the congestion event notifications to the VMs, where the host server comprises a Virtual IO Server (VIOS) with Nport ID Virtualization (NPIV) technology to manage the VMs. The embodiment enables efficiently and effectively implementing intelligent congestion control with a VIOS host server.

An embodiment of the present disclosure further includes providing a VM multipath IO driver within each VM of the plurality of VMs to throttle the IO operations of the respective VMs. The embodiment enables efficiently and effectively implementing intelligent congestion control using the VM multipath IO driver.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

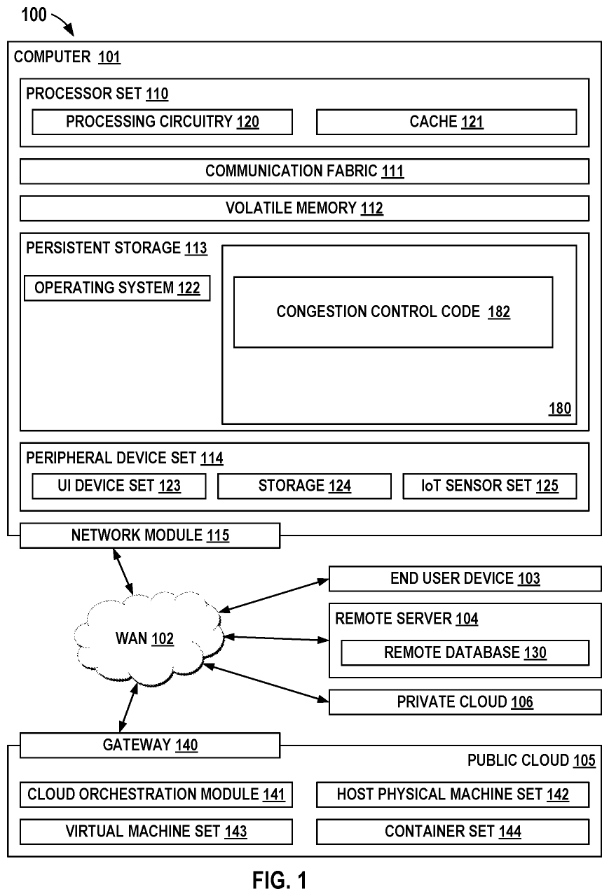

Referring to FIG. 1, a computing environment 100 contains an example of an environment for the execution of at least some of the computer code involved in performing the inventive methods, such as a Congestion Control Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Disclosed embodiments provide methods, systems, and computer program products for implementing intelligent congestion control in FC communication paths of a virtual environment. Embodiments of the present disclosure provide new techniques enabling effective and efficient intelligent congestion control based on a configured throttling factor of each VM in a zone. Disclosed embodiments provide intelligent congestion control using configured parameters of each VM including a configured throttle factor, where the configured parameters are based on an associated priority of workloads running on respective VMs. Disclosed embodiments use FPIN congestion events to identify congestion and throttle application I/O data transfer associated with respective VMs based the configured throttling factor. In a disclosed embodiment, a priority and weight are configured for each VM based on respective criticality of a workload running on such as VM, such as one of a low, medium or high (e.g., critical) priority of the VMs in a zone. In accordance with disclosed embodiments, VMs running critical workloads generally are not affected by a congestion event and continue normal I/O operations when congestion exists in a storage area network (SAN).

Disclosed embodiments use FPIN events of congestion notifications generated by a FC fabric, which are received by a host server, such as a virtual I/O server. In accordance with disclosed embodiments, the virtual I/O server communicates the received FPIN congestion notification to each of the registered VMs in a zone together with a throttle factor. The respective VMs process the FPIN congestion notification using its throttle factor to throttle I/O operations of associated applications through the congested path. In a disclosed embodiment, throttling inside the VM based on the congestion factor received with FPIN event, starts with only the VM group having a low priority of the respective VM groups having priorities of low, medium and critical (e.g. high). For example, throttling the IO operations of only the VMs of the low priority VM group initially is performed for a specific period of time, such as a threshold time period indicated in a Payload of the FPIN congestion notification, or until the congestion cleared notification is received. In a disclosed embodiment, when the congestion still exists at the end of an initial defined time period, throttling the IO operations continues with the VMs of the low priority VM group and with throttling the IO operations of the VMs of the medium priority VM group, based on the congestion factor for the medium priority VM group. In a disclosed embodiment, when the congestion still exists after one or more additional specific time periods, throttling the IO operations continues for all the VMs including throttling the IO operations of the critical priority VM group, based on the congestion factor for the critical priority VM group. In a disclosed embodiment, in response to the congestion cleared, restoring the VMs workload of the VMs is performed in reverse VM priority order, i.e. high, medium and low priorities to avoid triggering another FPIN congestion event.

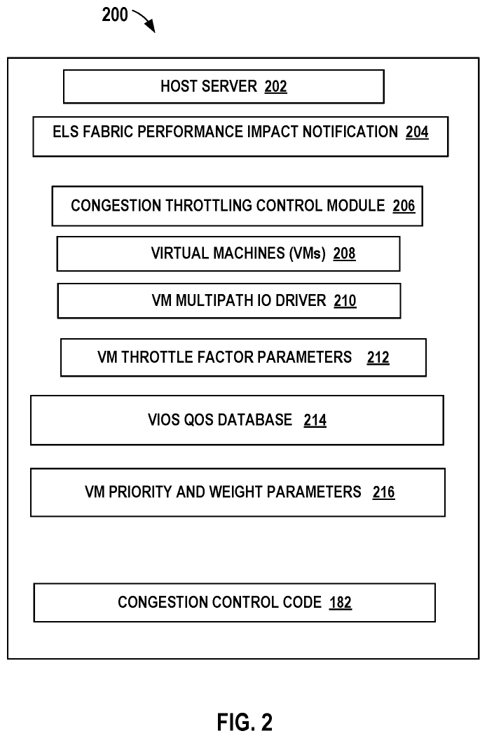

FIG. 2 illustrates an example system 200 for implementing congestion control in Fibre channel (FC) communication paths of one or more disclosed embodiments. System 200 provides congestion control in FC communication paths of one or more disclosed embodiments. System 200 can be used in conjunction with the computer 101 and the Congestion Control Code 182 of FIG. 1 for implementing inventive methods of a disclosed embodiment.

System 200 includes one or more host servers 202 to manage virtual machines for FC communications (e.g., such as a Virtual IO Server (VIOS) with Nport ID Virtualization (NPIV)). System 200 includes an ELS, FPIN 204 sending FPIN congestion events to the VIOS host server 202. System 200 includes a Congestion Throttling Control Module 206 of disclosed embodiments for operatively controlling a plurality of VMs 208 of the host server 202. In a disclosed embodiment, each VM 208 includes a VM Multipath IO Driver 210 used to throttle IO operations of the VM based on a configured value of an associated Throttle factor of VM Throttle Factor Parameters 212, stored in Virtual IO Server (VIOS) QOS Database 214. The VIOS QOS Database 212 stores VM Priority and Weight Parameters 214 of each VM in a zone of the respective host servers 202 of system 200, and the VM Throttling Factor Parameters 216 of each VM.

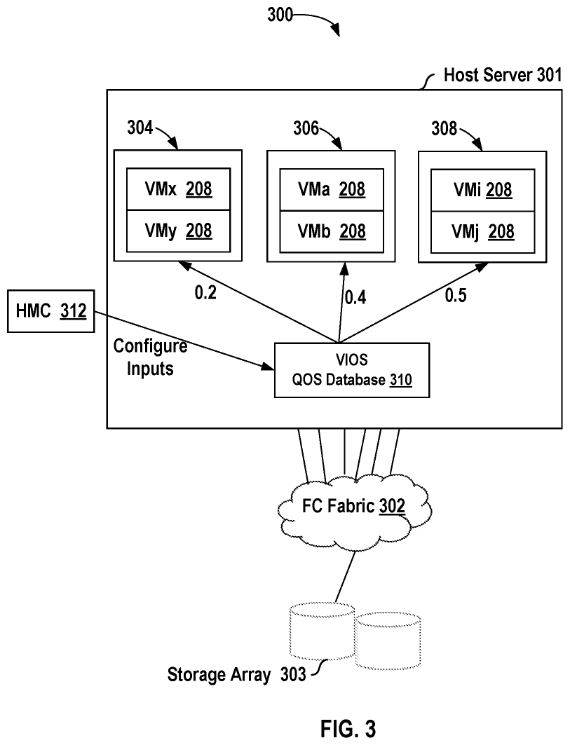

FIG. 3 illustrates an example computing environment 300 of system 200 with example details of an illustrative simplified host server 301 of a disclosed embodiment (e.g., host server 202 of FIG. 2) for implementing congestion control in communication paths of a FC fabric 302 coupled to at least one storage array 303. Host server 301 includes a central processing unit and memory and may be implemented by a computer, a server, a central electronics complex (CEC), or a multiple processor computer system. In a disclosed embodiment, the host server 301 comprises a Virtual I/O Server (VIOS) with NPIV technology to manage VMs 208 for congestion control of FC communication paths in virtual environments. In accordance with a disclosed embodiment, the NPIV FC standard enables creating multiple virtual ports on a single physical node port (N_Port), with each virtual port appearing as a unique entity to the FC network NPIV of the FC fabric 302.

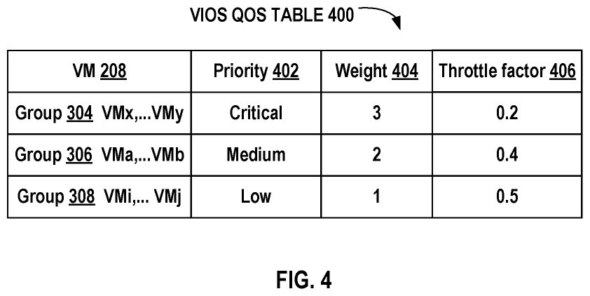

In a disclosed embodiment, the host server 301 includes a plurality of VM groups 304, 306, and 308 of one or multiple VMs 208, where each VM group has common Quality of Service (QOS) parameters. FIG. 4 provides an illustrative VIOS QOS TABLE 400 of example VM QOS parameter values for the common QOS parameters of the VMs 208 of the respective VM groups 304, 306, and 308, for example, of respective critical priority VMs, medium priority VMs, and low priority VMs. As shown, VM group 304 includes one or multiple critical priority VMs 208, VMx, VMy, VM group 306 includes one or multiple medium priority VMs 208, VMa, VMb, and VM group 308 includes one or multiple low priority VMs 208, VMi, VMj. As shown, the host server 301 includes a VIOS QOS Database 310, (e.g., VIOS QOS Database 214 of FIG. 2), used to obtain a respective throttle factor 212 for each VM 208 in the zone of host server 301. A respective example value of throttle factor 212 (e.g., obtained from the VIOS QOS database 310) is indicated at a line labeled 0.2 to the critical priority VM group 304, indicated at a line labeled 0.4 to the medium priority VM group 304, and indicated at a line labeled 0.5 to the low priority VM group 308. A hardware management console (HMC) 312 configures the QOS parameter values of each VM 208 based on the workload running on the VM, which are transmitted to the host server 301 as indicated at a line Configure Inputs, and stored to the VIOS QOS database 310 as part of system configuration.

Referring to FIG. 4, the illustrated VIOS QOS Table 400 provides example VM QOS parameter values for the respective VM groups 304, 306, and 308. The example parameter values of QOS Table 400 include Priority 402, Weight 404, and Throttle factor 406 and are common values for each of the VMs 208 of the respective VM groups 304, 306, and 308. As shown, the VMs 208, VMx, VMy of VM group 304 include common QOS parameters values of critical for Priority 402, 3 for Weight 404, and 0.2 for Throttle factor 406. As shown, the VMs 208, VMa, VMb of VM group 306 include common QOS parameters values of medium for Priority 402, 2 for Weight 404, and 0.4 for Throttle factor 406. As shown, the VMs 208, VMi, VMj of VM group 308 include common QOS parameters values of low for Priority 402, 1 for Weight 404, and 0.5 for Throttle factor 406. As shown in the illustrated examples, the respective throttle factors 406 enable different throttling and data transfer performance based on the respective priority of the respective VM groups 304, 306, and 308. As shown, the higher throttle factors 406 of 0.5 for the low priority VM group 308 for VMi-VMj provides higher throttling of IO operations, relative to the throttle factors 406 of 0.4 for the medium priority VM group 306 and the throttle factors 406 of 0.2 for the critical priority VM group 304. The VMs having a critical VM priority, (e.g., VMs running critical workload) initially are not affected by a congestion event and are provided higher priority and less performance impact based on its throttle factor during throttling of IO operations of the VMs for a congestion event.

For example, in congestion control operation, such as corresponding the illustrated examples, the VIOS host server 301 receives a congestion event notification of a given FPIN congestion event when congestion occurs and initially transmits the given FPIN event notification with the Throttle factor 406 of 0.5 value to the low priority VMs 208, VMi, VMj. The respective Multipath I/O driver 210, inside the VMs 208, VMi, VMj of the low priority VM group 308, throttles the I/O operations of the low priority VMs based on the throttle factor sent by the VIOS host server 301. The VIOS host server 301 initially transmits the configured Throttle factor 406 to the low priority VMs 208, VMi, VMj to first throttle the low priority VM group 308; and initially throttling is not enabled in either the medium priority VMs 208, VMa, VMb or the critical priority VMs 208, VMx, VMy. For example, initially a zero value for the Throttle factor 406 can be transmitted with the given FPIN event notification for the higher priority VM groups 304 and 306. Depending on the duration of the FPIN event, (e.g., when the congestion persists after a defined initial throttling time interval), VIOS host server 301 next transmits the FPIN event notification with the Throttle factor 406 of 0.4 value to the medium priority VMs 208, VMa, VMb, to throttle IO operations of both the low priority VM group 308 and the medium priority VM group 306 based on their respective throttle factor. When needed, VIOS host server 301 also transmits the FPIN event notification with the Throttle factor 406 of 0.2 value to the critical priority VMs 208, VMx, VMy, to throttle IO operations of all VMs of the high priority group 304, the medium priority group 306 and the low priority group 308, throttling VMs of each group based on its respective throttle factor.

In a disclosed embodiment, for example, when the event expiration descriptor threshold value for the given FPIN event notification occurs without receiving a FPIN clear notification, the VIOS host server 301 incrementally increases throttling of IO operations. That is, the VIOS host server 301 transmits the given FPIN event notification with the second throttle factor 406 of 0.4 value to the medium priority VMs 208, VMa, VMb, to throttle the I/O operations of the medium priority VMs 208 based on the second throttle factor and continuing to throttle the I/O operations of the low priority VMs 208 based on the first throttle factor. Based on the time period of congestion, VIOS host server 301 may also transmit the given FPIN event notification with the critical Throttle factor 406 of 0.2 value to the critical priority VMs 208, VMi, VMj, for also throttling the I/O operations of the critical priority VMs 208 based on the critical throttle factor.

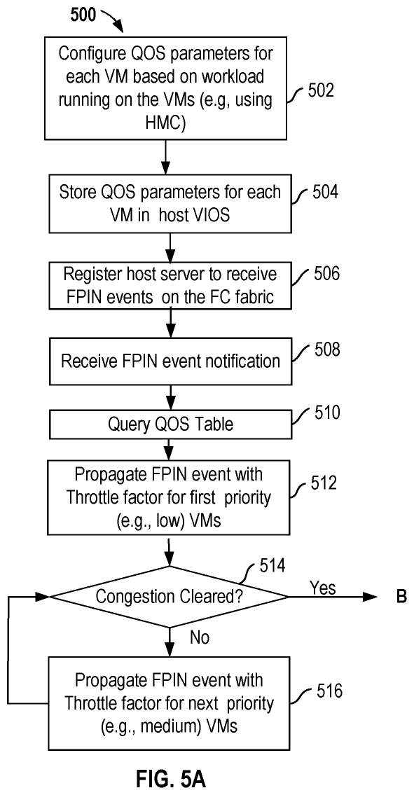

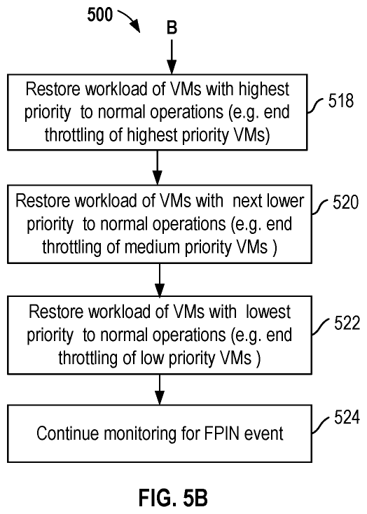

FIGS. 5A and 5B together illustrate example operations of an example method 500 for implementing congestion control in FC communication paths of virtual environments of one or more disclosed embodiments. The method 500 can be implemented by the system 200 and host server 301 in conjunction with the computer 101 of the computing environment 100 of FIG. 1 with the Congestion Control Code 182 of disclosed embodiments.

Referring to FIG. 5A, at block 502, system 200 configures QOS parameters for each VM 208 based on the workload running on the respective VMs, for example, using the HMC 312 to provide QOS parameter values to the VIOS host server 301 as part of system configuration. At block 504, system 200 stores QOS parameter values in the host VIOS server, for example, stored in the VIOS QOS database 310 of host server 301.

At block 506, system 200 registers the host server 301 with the ELS, FPIN 204 to receive FPIN events of FC paths on the FC fabric 302. The ELS FPIN includes notification descriptors for FPIN events including notification descriptors for one or more of Link Integrity, Delivery Notification, Peer Congestion and Link Congestion for each detected event. With a notification descriptor for Link Congestion (e.g., between host 301 and FC fabric 302) or a notification descriptor for Peer Congestion (e.g., between FC fabric 302 and target storage array 303), the respective FPIN events are sent to the host server 301, for example at the rate indicated by a threshold time interval value in an Event Threshold field to the congestion event notification.

At block 508, system 200 receives a FPIN congestion event notification, (e.g., an FPIN event with notification descriptor for Link Congestion or notification descriptor for Peer Congestion).

At block 510, system 200 queries the QOS Table, (e.g., the host server queries the VIOS QOS database 310 for QOS parameter values of the VMs for the congestion FPIN event).

At block 512, system 200 propagates the FPIN event notification with the throttle factor for the first priority (e.g., low priority) VMs to provide throttling of IO operations inside the low priority VM group 308 based on the factor received along with FPIN event. At decision block 514, system 200 determines after an initial time interval whether the congestion has cleared. For example, after the first time interval (e.g., the first time interval may equal an event threshold time interval value for the given FPIN event), and a FPIN clear notification has not been received, the VIOS host server 301 incrementally increases throttling at block 516. For example, at block 516, the VIOS host server 301 transmits the given FPIN congestion event notification with the Throttle factor 406 of 0.4 value to the medium priority VMs 208, VMa, VMb, for also throttling the I/O operations of the medium priority VMs 208 together with throttling the I/O operations the low priority VMs 208. Based on the time duration of the congestion event, VIOS host server 301 may also incrementally increase congestion control throttling to throttle the IO operations of all VMs including the critical priority VMs 208, VMx, VMy. For example, at block 516, following a set number of threshold time intervals or defined congestion duration period, the VIOS host server 301 transmits the given FPIN event notification with the Throttle factor 406 of 0.2 value to the critical priority VMs 208, VMx, VMy for also throttling the I/O operations of the critical priority VMs 208. In response to determining the congestion has cleared at decision block 514, operations continue at block 518 following entry point B in FIG. 5B.

Referring to FIG. 5B, at block 518, system 200 begins restoring VM workload for normal operations of the VMs, to initially end throttling of IO operations of the highest VM group, such as priority VMs 208, VMx, VMy. For example, system 200 sends a congestion cleared notification with a zero throttle factor to the respective VMs to stop throttling of IO operations of the respective VMs in a VM group order based on the VM priority of the respective VM groups. System 200 restores the VMs workload in reverse order than used for the incremental increasing throttling operations at block 512 and 516 of FIG. 5A; for example, the VIOS host server 301 first restores workload of the critical VMs, i.e., to stop throttling of IO operations of the highest priority VMs 208, VMx, VMy of VM group 304.

At block 520, system 200 restores the VM workload for normal operations of the VMs with the next lower (e.g., medium) priority, to stop throttling of IO operations of the medium priority VMs 208, VMa, VMb of VM group 306.

At block 522, system 200 restores the VM workload for normal operations of the VMs with a lowest priority, such as, stop throttling of IO operations of the low priority VMs 208, VMi, VMj of VM group 308.

At block 522, system 200 continues monitoring for FPIN events of disclosed embodiments.

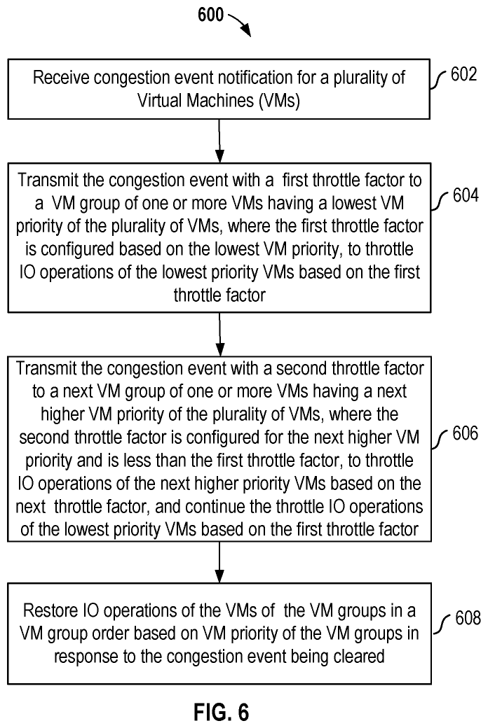

FIG. 6 illustrates a method 600 for implementing throttling congestion control in FC communication paths of virtual environments of one or more disclosed embodiments. Method 600 illustrates features and operations of method 500 of disclosed embodiments. The method 600 can be implemented by the system 200 in conjunction with the computer 101 of the computing environment 100 of FIG. 1 with the Congestion Control Code 182 and the host server 301 of disclosed embodiments.

At block 602, a congestion event notification for a plurality of VMs is received (e.g., received by host server 301). In a disclosed embodiment, the congestion event is a FPIN event generated by the FC fabric 302 for VMs 208 registered for the congestion notifications in a zone of a host server 301.

At block 604, the congestion event is transmitted with a first throttle factor to a first VM group of one or more Virtual Machines having a lowest priority of the plurality of VMs, where the first throttle factor is configured based on the lowest VM priority, to throttle IO operations of the lowest priority VMs based on the first throttle factor.

At block 606, based on congestion duration, the congestion event is transmitted with a second throttle factor to a next VM group of one or more VMs having a next higher VM priority (e.g., medium priority) of the plurality of VMs, wherein the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor. For example, based on persisting congestion, throttling IO operations are incrementally increased until the congestion event is cleared. For example, based on the overall time period of congestion, VIOS host server 301 may also transmit the given FPIN event notification with a third Throttle factor to the critical priority VMs 208, VMi, VMj, for throttling the I/O operations of the critical priority VMs 208 of group 304 based on the third throttle factor.

At block 608, in response to the congestion event being cleared, the IO operations of the VMs are sequentially restored in a VM group order based on the VM priority of the respective VM groups. In a disclosed embodiment, IO operations of VMs of respective VM groups are sequentially restored in a VM group order of a highest VM priority, a medium VM priority, and a lowest VM priority. For example, rather than restoring the workload of each VM at once, the workload of VMs of respective VM groups are incrementally restored, to avoid immediately triggering another congestion event. In a disclosed embodiment, for example the IO operations of VMs of the highest priority VM group are initially restored, and the IO operations of VMs of next lower priority VM groups are restored for each of the plurality of VMs after a predefined time period after restoring IO operations of the VMs of the highest priority 304. In a disclosed embodiment, sequentially restoring the IO operations of the VMs in the VM group order based on the VM priority of the respective VM groups includes sequentially transmitting a congestion event cleared notification with a throttle factor of zero in the VM group order of a highest VM priority, a medium VM priority, and a lowest VM priority.

While the foregoing is directed to embodiments of the present invention, other and further embodiments of the invention may be devised without departing from the basic scope thereof, and the scope thereof is determined by the claims that follow.

What is claimed is:

1. A method comprising:
receiving a congestion event notification for a plurality of Virtual Machines (VMs);
transmitting the congestion event notification with a first throttle factor to a first VM group of one or more VMs having a lowest VM priority of the plurality of VMs, wherein the first throttle factor is configured based on the lowest VM priority, to throttle IO operations of the lowest priority VMs based on the first throttle factor;
transmitting, based on congestion duration, the congestion event notification with a second throttle factor to a next VM group of one or more VMs having a next higher VM priority of the plurality of VMs, wherein the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and
sequentially restoring IO operations of the VMs in an order based on the VM priority of the respective VM groups in response to the congestion event being cleared.

2. The method of claim 1, further comprising:
configuring VM parameters of each VM of the plurality of VMs to define one or more VM parameters of a VM priority, a VM weight, and the throttle factor, wherein the throttle factor is configured based on the VM priority and the VM weight.

3. The method of claim 2, wherein configuring the VM parameters of each VM of the plurality of VMs is based on a respective priority of one or more applications running on the respective VMs.

4. The method of claim 1, wherein receiving the congestion event notification further comprises receiving a Fabric Performance Impact Notification (FPIN) congestion event for the plurality of VMs.

5. The method of claim 1, wherein transmitting the congestion event notification with the first throttle factor to the first VM group of one or more VMs having the lowest VM priority of the plurality of VMs further comprises:
transmitting the congestion event notification with a throttle factor of zero to one or more respective VM groups of VMs having the next higher VM priority of the plurality of VMs.

6. The method of claim 1, wherein transmitting, based on the congestion duration, the congestion event notification with the second throttle factor to the next VM group of one or more VMs having the next higher VM priority further comprises:
transmitting the congestion event notification with a medium priority throttle factor to the next VM group of one or more VMs having a medium VM priority, wherein the medium priority throttle factor is configured based on the medium VM priority, to throttle IO operations of the medium priority VMs based on the medium priority throttle factor, and
continuing to throttle IO operations of the lowest priority VMs based on the first throttle factor; and
transmitting, based on the congestion duration, the congestion event notification with a critical priority throttle factor to a next VM group of one or more VMs having critical VM priority, wherein the critical priority throttle factor is configured based on the critical VM priority, to throttle IO operations of the critical priority VMs based on the critical priority throttle factor, and
continuing to throttle IO operations of both the medium priority VMs based on the medium priority throttle factor, and the lowest priority VMs based on the first throttle factor.

7. The method of claim 1, wherein sequentially restoring IO operations of the VMs in a VM group order based on the VM priority of the respective VM groups further comprises:
transmitting a congestion event cleared notification with a throttle factor of zero to a VM group of VMs having a highest VM priority of the plurality of VMs to end the throttle operations of the VMs having the highest VM priority.

8. The method of claim 7, further comprises:
transmitting the congestion event cleared notification with the throttle factor of zero to the VM group of VMs having a medium VM priority of the plurality of VMs to end the throttle operations of the VMs having the medium VM priority; and
transmitting a congestion event clear notification with a throttle factor of zero to the VM group of VMs having the lowest VM priority of the plurality of VMs to end the throttle operations of the VMs having the lowest VM priority.

9. The method of claim 1, further comprising:
providing a host server for receiving the congestion event notification and transmitting the congestion event notifications to the VMs, wherein the host server comprises a Virtual I/O Server (VIOS) with Nport ID Virtualization (NPIV) technology to manage the VMs.

10. The method of claim 1, further comprising:
providing a VM multipath IO driver within each VM of the plurality of VMs to throttle IO operations of the VM based on the throttle factor configured for each VM.

11. A system, comprising one or more computer processors, and a memory containing a program which when executed by the one or more computer processors performs an operation, the operation comprising:
receiving a congestion event notification for a plurality of Virtual Machines (VMs);
transmitting the congestion event notification with a first throttle factor to a first VM group of one or more VMs having a lowest VM priority of the plurality of VMs, wherein the first throttle factor is configured based on the lowest VM priority, to throttle IO operations of the lowest priority VMs based on the first throttle factor;
transmitting, based on congestion duration, the congestion event notification with a second throttle factor to a next VM group of one or more VMs having a next higher VM priority of the plurality of VMs, wherein the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and
sequentially restoring IO operations of the VMs in a VM group order based on the VM priority of the respective VM groups in response to the congestion event being cleared.

12. The system of claim 11, further comprising:
configuring VM parameters of each VM of the plurality of VMs to define one or more VM parameters of a VM priority, a VM weight, and the throttle factor, wherein the throttle factor is configured based on the VM priority and the VM weight.

13. The system of claim 11, wherein receiving the congestion event notification further comprises receiving a Fabric Performance Impact Notification (FPIN) congestion event for the plurality of VMs.

14. The system of claim 11, wherein transmitting the congestion event notification with the first throttle factor to the first VM group of one or more VMs having the lowest VM priority of the plurality of VMs further comprises:
transmitting the congestion event notification with a throttle factor of zero to one or more respective VM groups of VMs having the next higher VM priority of the plurality of VMs.

15. The system of claim 11, wherein sequentially restoring IO operations of the VMs in the VM group order based on the VM priority of the respective VM groups further comprises:
sequentially transmitting a congestion event cleared notification with a throttle factor of zero in the VM group order of a highest VM priority, a medium VM priority, and a lowest VM priority.

16. A computer program product comprising a computer-readable storage medium having computer-readable program code embodied therewith, the computer-readable program code executable by one or more computer processors to perform an operation comprising:
receiving a congestion event notification for a plurality of Virtual Machines (VMs);
transmitting the congestion event notification with a first throttle factor to a first VM group of one or more VMs having a lowest VM priority of the plurality of VMs, wherein the first throttle factor is configured based on the lowest VM priority, to throttle IO operations of the lowest priority VMs based on the first throttle factor;
transmitting, based on congestion duration, the congestion event notification with a second throttle factor to a next VM group of one or more VMs having a next higher VM priority of the plurality of VMs, wherein the second throttle factor is configured based on the next higher VM priority and is less than the first throttle factor, to throttle IO operations of the next higher priority VMs based on the second throttle factor, and continuing the throttle IO operations of the lowest priority VMs based on the first throttle factor; and
sequentially restoring IO operations of the VMs in a VM group order based on the VM priority of the respective VM groups in response to the congestion event being cleared.

17. The computer program product of claim 11, further comprising:
configuring VM parameters of each VM of the plurality of VMs to define one or more of a VM priority, a VM weight, and the throttle factor, wherein the throttle factor is configured based on the VM priority and the VM weight.

18. The computer program product of claim 16, wherein receiving the congestion event notification further comprises receiving a Fabric Performance Impact Notification (FPIN) congestion event for the plurality of VMs.

19. The computer program product of claim 16, wherein transmitting the congestion event notification with the first throttle factor to the first VM group of one or more VMs having the lowest VM priority of the plurality of VMs further comprises:
transmitting the congestion event notification with a throttle factor of zero to one or more respective VM groups of VMs having the next higher VM priority of the plurality of VMs.

20. The computer program product of claim 16, wherein sequentially restoring IO operations of the VMs in the VM group order based on the VM priority of the respective VM groups further comprises:
sequentially transmitting a congestion event cleared notification with a throttle factor of zero in the VM group order of a highest VM priority, a medium VM priority, and a lowest VM priority.
